(19) United States
(12) Patent Application Publication
(10) Pub. No.: US 2025/0215022 A1
(43) Pub. Date: Jul. 3, 2025

(54) PLASMONIC METAL-ORGANIC FRAMEWORKS (MOF) NANOPARTICLES, METHOD OF PREPARATION AND USES THEREOF

(71) Applicant: B. G. NEGEV TECHNOLOGIES AND APPLICATIONS LTD., AT BEN-GURION UNIVERSITY, Beer-Sheva (IL)

(72) Inventors: Yossef WEIZMANN, Beer Sheva (IL); Ofir SHELONCHIK, Beer Sheva (IL)

(73) Assignee: B. G. NEGEV TECHNOLOGIES AND APPLICATIONS LTD., AT BEN-GURION UNIVERSITY, Beer-Sheva (IL)

(21) Appl. No.: 19/082,517

(22) Filed: Mar. 18, 2025

Related U.S. Application Data
(63) Continuation of application No. PCT/IL2023/051013, filed on Sep. 19, 2023.
(60) Provisional application No. 63/407,819, filed on Sep. 19, 2022.

(51) Int. Cl. C07F 7/00; C01G 7/00

(52) U.S. Cl. CPC C07F 7/00; C01G 7/00; C01P 2002/01; C01P 2002/72; C01P 2002/84; C01P 2004/03; C01P 2004/04; C01P 2004/16; C01P 2004/32; C01P 2004/42; C01P 2004/62; C01P 2004/64; C01P 2006/32

(57) ABSTRACT

Methods of synthesizing MOF materials are disclosed. Further, plasmonic MOF composites and uses thereof as a recyclable catalyst, for ultrafast desorption (e.g., of solvents), MOF activation are also disclosed.

### CROSS-REFERENCE TO RELATED APPLICATIONS

This application is a ByPass Continuation of PCT Patent Application No. PCT/IL2023/051013 having International filing date of Sep. 19, 2023, which claims the benefit of priority of: U.S. Provisional Application No. 63/407,819, filed Sep. 19, 2022, which are hereby incorporated by reference in their entirety.

### FIELD OF THE INVENTION

The present invention, in some embodiments thereof, relates to a method of synthesizing MOF materials. Further, the present invention, in some embodiments thereof, relates to plasmonic MOF nanoparticles and use thereof.

### BACKGROUND OF THE INVENTION

Metal organic frameworks (MOFs) are a class of materials consisting of metal ions or clusters connected by organic linkers into a crystalline structure. This unique arrangement results in highly porous materials, with enormous surface areas, that can be tailored for exact pore size and functionality by utilizing suitable ions/clusters and linkers. The remarkable properties and exceptional versatility demonstrated by MOFs have led to extensive research towards the development of applications in a variety of different fields such as gas storage and separation, drug delivery, sensing, catalysis, electronic devices, membranes. Thus, the synthesis of MOFs has become an area of wide interest.

Plasmonic nanoparticles (PNPs) are capable of converting light to heat via the “localized surface plasmon resonance” (LSPR) effect. The interaction between an incoming electromagnetic wave at the resonant frequency and the nanoparticle's conduction electrons initiates a cascade of events that ends by heat dissipation from the PNP. The resonant frequency is highly dependent on exact PNP geometry making the heating efficiency sensitive to subtle changes in PNP structure. The plasmonic effect has been extensively researched over the past few decades and has been introduced into various fields such as biosensing, spectroscopic applications and photothermal cancer therapy. Gold nanoparticles are exemplary plasmonic materials, with highly efficient light-to-heat conversion, excellent chemical stability and biocompatibility. Moreover, a variety of different gold nanostructures have well-defined syntheses facilitating the possibility of manipulating the photothermal activation wavelength by changing nanoparticle size and shape. Gold nano bipyramids (AuBPs) are an ideal example as their synthesis yields highly monodisperse structures and can be tuned to afford different size AuBPs. Furthermore, the unique bipyramidal shape has an intrinsic relatively narrow LSPR absorption band and remarkable conversion efficiency. These factors establish AuBPs as outstanding tunable light-to-heat nanoconverters.

To this end, MOF synthesis is performed via time consuming solvothermal methods. This synthetic approach suffers from being inefficient in terms of time and energy, a crucial disadvantage for large scale production of MOFs and a major setback in their transition from lab to industry. Consequently, fast, and efficient methods for industrial MOF syntheses are thus required.

### SUMMARY OF THE INVENTION

The present invention, in some embodiments thereof, relates to a method of synthesizing MOF by utilizing plasmonic nanoparticles. Furthermore, the present invention, in some embodiments thereof, encompasses plasmonic MOF particles.

According to an aspect of some embodiments of the present invention there is provided a composite comprising a metal-organic framework (MOF) and a plasmonic material, wherein: the composite is a crystalline solid; the plasmonic material is in a form of a plurality of nanoparticles, wherein each nanoparticle is encapsulated by an oxide shell; the plasmonic material is characterized by a photothermal activation wavelength in a range between 200 and 1200 nm, including any range between.

According to another aspect of some embodiments of the present invention there is provided a method of synthesizing the composite of the invention, comprising contacting a plasmonic material with one or more MOF precursor under appropriate conditions, thereby obtaining a mixture; and subjecting the mixture to a light irradiation sufficient for inducing a photothermal activation of the plasmonic material, thereby obtaining the composite.

According to another aspect of some embodiments of the present invention there is provided a method of synthesizing a MOF, comprising contacting a photothermal material with one or more MOF precursor under appropriate conditions, thereby obtaining a mixture; and subjecting the mixture to a light irradiation sufficient for inducing a photothermal activation of the photothermal material, thereby obtaining the MOF.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIGS. 1A-G are images and graphs showing photothermal synthesis of UiO-66. (1A), Scheme of PPR synthesis of UIO-66 utilizing a 850 nm, 100 W LED. (1B), Temperature profiles of UIO-66 photoinduced syntheses with different concentrations of AuBP₈₅₀. (1C), UIO-66 mass as a function of time for PPRs in 1A. (1D), Images of the progress of 20 ml syntheses at 100° C. Initial MOF formation marked by red squares. The images are ordered from left to right, so the left column represents 0 min of reaction, right to it 10 min, then intervals of 5 min. Upper row: photothermal synthesis. Middle row: conventional synthesis with AuBPs. Bottom row: conventional synthesis without AuBPs. (1E), product mass as a function of time for PPRs at different temperatures. (1F), PXRD results of product from PPRs in 1E. (1G), BET N₂ adsorption isotherms of product from PPRs in 1E.

FIGS. 2A-F: images, micrographs and graphs showing controlled insertion of AuBPs into UIO-66. (2A-C), SEM images of AuBP@UIO-66 that were synthesized at different temperatures of 60° C. (2A), 80° C. (2B), and 100° C. (2C), the AuBPs are represented as the bright dots. (2D), Images of the supernatants of the three samples. (2E), ICP-OES results of UIO-66 samples synthesized at different temperatures; (2F) UV-vis spectrum of the supernatant of the post-synthesis solutions of the AuBP@UIO-66.

FIGS. 3A-C: images, micrographs and PXRD patterns showing (3A) Photothermal synthesis scheme, SEM image and PXRD pattern of HKUST-1. (3B) Photothermal synthesis scheme, SEM image and PXRD pattern of MOF-5. (3C) Photothermal synthesis scheme, SEM image and PXRD pattern of MIL-88A. The white scale bar size is 5 m.

FIGS. 4A-C: images, micrographs and graphs showing Photothermal converter Plasmonic MOF. (4A) temperature profiles of AuBP@UIO-66 with different concentration of AuBPs irradiated with 850 nm LED. (4B) heating-cooling cycles of AuBP@UIO-66 (200D) between 40° C. to 180° C. and between 40° C. to 100° C. (4C) IR and regular pictures of AuBP@UIO-66 and UIO-66 before and during IR LED irradiation.

FIGS. 5A-D: graphs showing photothermal activation. (5A), temperature profiles of 22 mg of AuBP@UIO-66 that was soaked with different water volumes and irradiated by 850 nm LED. (5B), Recorded masses of AuBP@UIO-66 and UIO-66 before and after drying, using photothermal and conventional heating. Error bars represent the standard deviation according to three samples that were tested. (5C), N₂ adsorption isotherm of AuBP@UIO-66 activation via photothermal method. (5D), Surface area comparison between photothermal activation to other reported conventional activation processes.

FIG. 6: TEM image of AuBPs850@UIO-66 synthesized at 100° C. AuBPs@SiO2 are highlighted in red.

FIGS. 7A-E: EDS elemental mapping of AuBPs that were heated with ZrCl4 at 60° C. (7A), Au L series. (7B), O K series. (7C), Zr K series. (7D), Si K series. (7E), STEM image.

FIG. 8: N₂ isotherms of AuBP₈₅₀@UIO-66 before and after heating cycles.

FIG. 9: TEM image of AuBPs that adsorb light in the IR range (AuBP850). The darker shape is the gold bipyramid, the rounded grey shape is the silica shell.

FIG. 10: TEM images of encapsulated gold nanospheres (AuNS).

FIGS. 11A-B: TEM images of AuBPs850@UIO-66 synthesized at 60° C. (11B) and of AuBP@SiO2 (i.e. AuBP encapsulated by silica shell) (11A).

FIG. 12: TEM image of AuBPs₈₅₀@UIO-66 synthesized at 80° C.

FIG. 13: TEM image of AuBPs₈₅₀@UIO-66 synthesized at 100° C.

### DETAILED DESCRIPTION

The present invention, in some embodiments thereof, relates to a composite material comprising a metal-organic framework (MOF) and a plasmonic material, wherein the plasmonic material is in a form of nanoparticles, and is characterized by a photothermal activation wavelength in a range between about 200 and about 1200 nm, including any range between. In some embodiments, the plasmonic material is in a form of metal nanoparticles; wherein each metal nanoparticle is encapsulated by a metal/metalloid oxide shell. In some embodiments, the composite material is a solid material. In some embodiments, the composite material is a crystalline solid characterized by at least one X-ray diffraction (XRD) peak. In some embodiments, the MOF is in a crystalline state within the composite. In some embodiments, the XRD of the composite is predetermined by XRD pattern of the MOF. In some embodiments, the XRD of the composite is substantially identical to the XRD of the pristine MOF.

In another aspect, there is provided a composite comprising MOF and a plasmonic material, wherein a w/w concentration of the plasmonic material within the composite is at least 0.05%, at least 0.1%, at least 0.3%, at least 0.5%, at least 10%, between about 0.05 and about 20%, between about 0.1 and about 20%, between 0.1 and 10%, between 0.1 and 20%, between 0.5 and 10%, between 1 and 20%, between 3 and 20%, between 5 and 20%, between 1 and 10%, between 0.05 and 5%, between 0.05 and 3%, between 0.05 and 1%, including any range between.

In some embodiments, the plasmonic material is in amorphous state. In some embodiments, the composite is substantially devoid of crystalline plasmonic material.

In some embodiments, at least 0.1%, at least 0.5%, at least 1%, at least 10%, at least 20%, at least 30%, at least 50%, at least 75%, at least 80%, at least 85%, at least 87%, or at least 90% by weight of the composite is crystalline, including any value or range therebetween. Each possibility represents a separate embodiment of the invention. In some embodiments, the crystallinity of the composite, as disclosed herein, are determined by XRD. In some embodiments, the term “amorphous” is referred to a non-crystalline composition (e.g., devoid of a crystal lattice). In some embodiments, the amorphous phase contains domains that have observed organized order like in a crystalline phase but there is no significant or completely no signature of crystalline X-ray or electron diffraction patterns. In some embodiments, at least 50%, at least 75%, at least 80%, at least 85%, at least 87%, or at least 90%, or between 80 and 99% by weight of the MOF is in a crystalline state within the composite.

In some embodiments, the MOF is characterized by a substantial porosity, being capable of hosting, embedding or encapsulating the particles of the plasmonic material. In some embodiments, the composite comprises a core comprising the plasmonic material in contact with (or enclosed within) a MOF shell. In some embodiments, the plasmonic material is embedded within the MOF matrix. In some embodiments, each particle of the plasmonic material is surrounded by particles (or crystallites) of the MOF. In some embodiments, each particle of the plasmonic material forms a core and the MOF matrix forms a shell in contact with (or bound to) the core. In some embodiments, plasmonic material is homogenously distributed within the MOF matrix. In some embodiments, the particles of the plasmonic material is enclosed by the MOF matrix. In some embodiments, the particles of the plasmonic material are physisorbed and/or chemisorbed on or within the MOF matrix. In some embodiments, the plasmonic material is in contact with or bound to the MOF. In some embodiments, the composite consists essentially of (e.g. at least 90%, at least 95%, at least 99%, or between 90 and 99%, between 95 and 99.99% by weight of the composite) the MOF matrix doped with plasmonic material.

In some embodiments, the term “bound” refers to any non-covalent bond or interaction, such as electrostatic bond, dipole-dipole interaction, Van-der-walls' interaction, ionotropic interaction, hydrogen bond, hydrophobic interactions, pi-pi stacking, London forces, etc. In some embodiments, the non-covalent bond or interaction is a stable bond or interaction, wherein stable is as described herein.

In some embodiments, the term “porosity” as used herein refers to a material comprising pores, holes, voids, or empty space (optionally filled with a gas, such as air or an inert gas), within its network. However, porous layers may optionally comprise an additional substance in the spaces between the molecules of MOF, provided that at least a portion of the volume of the voids is not filled in by the additional substance. In some embodiments, the additional substance comprises the plasmonic material disclosed herein. Porosity is measured as a fraction (between 0 and 1) of the free volume or pore volume of the porous material relative to the total volume of the porous material, determined by well-known physical measurements, such as N₂ adsorption/desorption.

In some embodiment, porosity of the composite is between 0.1 to 0.99.

In some embodiment, porosity of the composite is 0.1, 0.2, 0.3, 0.4, 0.5, 0.6, 0.7, 0.8, 0.9, or 0.99, including any value and range therebetween.

In some embodiments, the term “composite”, as used herein, refers to a substantially uniform material which cannot be easily separated into individual constituents (e.g., the particles, and the MOF). In some embodiments, a composite is substantially devoid of phase separation or disintegration (also referred to herein as “stable” composite). In some embodiments, a composite is substantially devoid of a multi-layered structure. In some embodiments, the composite is a single-layer composite. In some embodiments, the composite is a homogenous single-layer composite.

In some embodiments, the term “layer”, refers to a substantially uniform thickness of a material. In some embodiments, the layer or film comprises a single layer, or a plurality of layers. In some embodiments, the term layer and the term film are used herein interchangeably.

In some embodiments, the composite is in a form of a bulk material. In some embodiments, the composite is in a form of a continuous MOF matrix doped with the plasmonic material. In some embodiments, the composite is in a form of a continuous MOF matrix doped with the plasmonic material, wherein the plasmonic material is homogenously or inhomogeneous distributed within the MOF matrix. In some embodiments, the plasmonic material is randomly (e.g. without any specific pattern) distributed within the MOF matrix.

In some embodiments, the MOF matrix is in a form of aggregated or agglomerated MOF particles, and wherein the plasmonic material is in a form of distinct particles (i.e. devoid of plasmonic material particle aggregates) distributed within the MOF matrix. In some embodiments, between 80 and 100%, between 80 and 95% by weight of the plasmonic material is in a form of distinct (non-aggregated) particles, i.e. distinct nanoparticles. In some embodiments, the composite is substantially devoid (e.g. not more than 5% of the total content of the plasmonic nanoparticles) of plasmonic material aggregates.

In some embodiments, the MOF is in a form of aggregated or agglomerated MOF nanoparticles, wherein an average particle size of the plasmonic material is greater (e.g. by at least 1.5, at least 2, at least 5 at least 10 fold, or between 1.5 and 20 fold, between 1.5 and 10 fold, including any range between) than an average primary particle size of the MOF.

In some embodiments, the MOF is a crystalline solid in a form of a particulate solid matter, and is characterized by an average particle size between 10 nm and 500 μm, between 10 and 500 nm, between 10 and 500 nm, between 50 nm and 500 um, between 10 and 100 nm, between 100 and 500 nm, between 50 and 300 nm, between 10 and 500 nm, between 50 and 200 nm, between 100 and 300 nm, between 300 and 500 nm, between 0.1 μm and 0.5 μm, between 0.1 μm and 500 μm, including any range between. In some embodiments, the average particle size refers to a dry size (e.g., as determined by SEM) of the primary particles within the composite.

In some embodiments, the composite is characterized by an average particle size between 10 nm and 500 μm, between 50 and 500 nm, between 10 and 500 nm, between 10 and 100 nm, between 100 and 500 nm, between 50 and 300 nm, between 10 and 500 nm, between 50 and 200 nm, between 100 and 300 nm, between 300 and 500 nm, between 0.1 μm and 0.5 μm, between 0.1 μm and 500 μm, including any range between. In some embodiments, the average particle size refers to a dry size (e.g., as determined by SEM) of the primary particles within the composite.

In some embodiments, the plasmonic material comprises a plasmonic metal particle, wherein the plasmonic metal particle is characterized by an average particle size between 0.001 μm and 0.5 μm, between 1 and 200 nm, between 10 and 200 nm, between 10 and 100 nm, between 50 and 500 nm, between 10 and 500 nm, between 10 and 100 nm, between 100 and 500 nm, between 50 and 300 nm, between 10 and 500 nm, between 50 and 200 nm, between 10 and 200 nm, between 100 and 300 nm, between 300 and 500 nm, between 0.1 μm and 0.5 μm, including any range between. In some embodiments, the average particle size of the plasmonic metal particle refers to a dry particle size (e.g., as determined by SEM).

In some embodiments, the plasmonic material is characterized by an average particle size between 0.001 μm and 0.5 μm, between 1 and 200 nm, between 10 and 200 nm, between 10 and 100 nm, between 50 and 500 nm, between 10 and 500 nm, between 10 and 100 nm, between 100 and 500 nm, between 50 and 300 nm, between 10 and 500 nm, between 50 and 200 nm, between 10 and 200 nm, between 100 and 300 nm, between 300 and 500 nm, between 0.1 μm and 0.5 μm, including any range between (e.g., as determined by SEM).

In some embodiments, a weight per weight (w/w) ratio between the plasmonic material and the MOF within the composite is between about 1:1000 and about 1:5, between about 1:1000 and about 1:10, between 1:10 and 1:1000, between 1:10 and 1:100, between 1:1 and 1:100, between 1:10 and 1:50, between 1:50 and 1:1000, between 1:50 and 1:10,000, between 1:100 and 1:1000, between 1:100 and 1:10,000, including any range between.

In some embodiments, the MOF comprises a metal in a crystalline state. In some embodiments, at least 50%, at least 60%, at least 70%, at least 80%, at least 90%, at least 95%, at least 99%, at least 99.5% by weight (or atomic percentage) of the metal within the MOF is in a crystalline state. Exemplary XRD of the composite are presented herein (see Figures and Appendix).

Exemplary MOF include but are not limited to Zr-based MOF, Fe-based MOF, Cu-based MOF, and Zn-based MOF, including any mixture thereof. Specific examples include but are not limited to UiO-66, MIL-88A, HKUST-1 and MOF-5, including any mixture thereof.

In some embodiments, the plasmonic material is characterized by a photothermal activation wavelength in a range between about 200 and 1200 nm, between about 300 and 1000 nm, between about 400 and 900 nm, between about 400 and 1000 nm, between 500 and 900 nm, between 600 and 900 nm, including any range between.

In some embodiments, the plasmonic material is in a form of metal nanoparticles. In some embodiments, the metal nanoparticles are plasmonic particles. In some embodiments, the metal nanoparticles consists or consist essentially of an elemental state metal. The term “plasmonic particles” is well understood by a skilled artisan and refers to the ability of the particles to convert light to heat via the “localized surface plasmon resonance” (LSPR) effect. In some embodiments, the elemental state metal is or comprises one or more transition metal(s) such as Ag, Fe, Cu, Pd, Ni, Pt, including any combination and any alloy thereof. In some embodiments, the elemental state metal is or comprises a noble metal, or an alloy thereof. In some embodiments, the metal nanoparticles are plasmonic particles characterized by an activation wavelength in the UV-Vis-near IR range (e.g. between about 200 and 1000 nm).

In some embodiments, the metal nanoparticles are noble metal nanoparticles. In some embodiments, the metal nanoparticles are spherical or substantially non-spherical particles (e.g. pyramidal-shaped particles). In some embodiments, the metal nanoparticles are enclosed within a support matrix. Without being limited, it is postulated that the support matrix stabilizes the nanoparticles, preventing reorganization thereof and thus preventing formation of spherical particles, being substantially devoid of plasmonic properties.

In some embodiments, the support matrix is an inert (i.e. non-plasmonic) matrix encapsulating the plasmonic material (e.g. metal nanoparticles), and is devoid of reactivity towards the plasmonic material. In some embodiments, the support matrix is a continuous layer encapsulating the plasmonic material. In some embodiments, the support is a porous support. In some embodiments, the support is or comprises an oxide. In some embodiments, the oxide is selected from a metalloid oxide, and a metal oxide (e.g. titanium oxide, zirconium oxide, zinc oxide, aluminum oxide, etc.) In some embodiments, the metalloid oxide comprises silica.

In some embodiments, the plasmonic material is in a form of metal nanoparticles embedded within, encapsulated within, or enclosed by an oxide material. In some embodiments, the plasmonic material is in a form of a core-shell particle comprising a core (metal core) consisting essentially of plasmonic metal nanoparticle, and further comprising a shell surrounding the core, wherein the shell consists essentially of porous (e.g. mesoporous) oxide material, and wherein the plasmonic metal nanoparticle consists essentially of (i.e., at least 90%, at least 95%, at least 99%, or at least 99.9% by weight of the plasmonic metal nanoparticle) an elemental state metal, such as a transition metal. Exemplary transition metals are as disclosed hereinabove.

In some embodiments, the shell of the core shell particle consists essentially of mesoporous silica. In some embodiments, the support consists essentially of mesoporous silica. In some embodiments, the metal cation content of the metal nanoparticles (i.e. of the core) is at most 5%, at most 1%, at most 0.1% by weight, or the metal core is devoid of non-elemental metal.

In some embodiments, the plasmonic material within the composite is in a form of core-shell particles as described hereinabove, wherein a metal of the MOF is bound to the shell of the plasmonic material. In some embodiments, the composite is described hereinabove comprising a metal/metalloid oxide based support matrix (or shell) of the plasmonic material, and wherein a metal of the MOF is bound to the metal/metalloid oxide based support matrix. Binding of the metal to the metal/metalloid oxide based support matrix can be determined by EDS (as disclosed in the Examples section).

In some embodiments, the plasmonic material comprises a plasmonic metal particle enclosed within the support matrix, wherein the plasmonic material is characterized by an average particle size between 0.1 μm and 10 μm, between 1 and 200 nm, between 10 and 200 nm, between 10 and 100 nm, between 50 and 500 nm, between 10 and 500 nm, between 10 and 100 nm, between 100 and 500 nm, between 50 and 300 nm, between 10 and 500 nm, between 50 and 200 nm, between 10 and 200 nm, between 100 and 300 nm, between 300 and 500 nm, between 0.1 μm and 0.5 μm, between 0.5 μm and 10 μm, including any range between. In some embodiments, the average particle size of the plasmonic metal particle refers to a dry particle size (e.g., as determined by SEM).

In some embodiments, the thickness of the shell (or support matrix) relative to the cross-section of the core (i.e., plasmonic metal particle) within the core-shell particle is between 1:3 and 3:1, between 1:2 and 3:1, between 1:1 and 3:1, between 1:1 and 2:1, including any range between. In some embodiments, the thickness of the shell is between 10 and 300 nm, between 10 and 20 nm, between 50 and 200 nm, including any range between.

In some embodiments, the plasmonic material is substantially amorphous. In some embodiments, the plasmonic material further encompasses a photothermal material. In some embodiments, the photothermal material is a plasmonic material comprising carbon nanoparticle(s), 1D or 2D material, borophene, boron-nitride nanotube, a boron-based 2D material, titanium dioxide nanoparticle(s), or any combination thereof. Other photothermal material are known in the art. In some embodiments, carbon nanoparticle comprises carbon black, carbon fiber, fullerenes, carbon nanotube, carbon dot, graphene, graphene oxide, activated charcoal or any combination thereof.

In some embodiments, plasmonic material comprises a plasmonic metal nanoparticle. In some embodiments, plasmonic metal nanoparticle comprises a noble metal particle. In some embodiments, plasmonic metal nanoparticle comprises gold nanoparticle (gold nano-, and/or micro-flakes; AuBPs, etc.), silver nanoparticle, or both. Other plasmonic materials are known in the art. In some embodiments, plasmonic metal nanoparticle is a magnetic particle including iron oxide or nickel as a magnetic components, such as SPION, and further comprising a plasmonic metal, as disclosed herein. Optionally, magnetic particles are core-shell particles.

In some embodiments, the plasmonic material is in a form of noble metal nanoparticles. In some embodiments, the plasmonic material is in a form of noble metal nanoparticles characterized by photothermal activation wavelength in a range between about 500 and about 1000 nm, between about 500 and about 600 nm, between about 600 and about 900 nm, between 700 and 900 nm, between 750 and 900 nm, between about 500 and about 900 nm, between 800 and 900 nm, including any range between. In some embodiments, the plasmonic material comprises or consist essentially of Au nanoparticles. In some embodiments, the Au nanoparticles comprise gold nano bipyramids (AuBP), gold nanospheres (AuNS), nanorods (AuNR), Au cubes, Au stars, and any combination thereof. In some embodiments, the plasmonic material comprises or consist essentially of gold nano bipyramids (AuBP). In some embodiments, the plasmonic material comprises AuBP and/or AuNS characterized by photothermal activation wavelength in a range between about 500 and about 1000 nm, between about 500 and about 600 nm, between about 600 and about 900 nm, between 700 and 900 nm, between 750 and 900 nm, between about 500 and about 900 nm, between 800 and 900 nm, including any range between.

In some embodiments, the composite is characterized by a BET surface area of at least about 100 m²/g, at least about 300 m²/g, at least about 500 m²/g, at least about 700 m²/g, at least about 1000 m²/g, at least about 2000 m²/g, at least about 3000 m²/g, between about 700 and 3000 m²/g, including any range between. In some embodiments, the composite is characterized by a greater BET surface area as compared to a control (i.e. MOF with the same composition, which is not synthesized by photothermal activation). In some embodiments, greater BET comprises at least 10%, at least 20, at least 30%, or between 10 and 50%, between 10 and 100% greater BET value, as compared to control.

In some embodiments, the composite of the invention and/or the plasmonic material is devoid of a polymeric dispersant.

In some embodiments, the composite of the invention is a plasmonic composite. In some embodiments, the plasmonic composite is configured to emit thermal radiation upon light irradiation at the photothermal activation wavelength. In some embodiments, the thermal radiation emitted by the composite comprises a temperature increase of the composite and/or ambient solvent by at least 10° C., at least 50° C., at least 100° C., at least 150° C., at least 200° C., up to about 500° C., up to about 300° C., up to about 200° C., up to about 150° C., up to about 100° C., including any range between. The temperature increase of the composite/ambient solvent wherein the composite is dispersed is determined based on a temperature of the same composite/solvent before irradiation.

In some embodiments, the thermal radiation emitted by the composite comprises a temperature increase of a solvent comprising the composite dispersed therewithin from about 25 at about 250° C. after 5 minutes irradiation time, wherein a concentration of the composite within the solvent corresponds to about 60 ppm of the plasmonic material.

In some embodiments, the thermal radiation emitted by the composite comprises a temperature increase of a solvent from about 40 at about 180° C. after 22 seconds irradiation time, wherein a concentration of the composite within the solvent corresponds to about 240 ppm of the plasmonic material.

In some embodiments, the composite of the invention is a photothermal catalyst. In some embodiments, the composite of the invention is for use as a catalyst in a photothermal synthesis of MOF, or in a photothermal synthesis of the composite of the invention (where the composite is used as the photothermal material). In some embodiments, the composite of the invention is configured to retain its plasmonic properties upon prolonged irradiation (e.g. continuous irradiation or repetitive irradiation cycles). In some embodiments, prolonged irradiation comprises a time range between 1 and 24 hours, between 1 and 1000 hours, between 10 and 1000 hours, between 1 and 500 hours, between 100 and 1000 hours, between 100 and 500 hours, including any range between.

In another aspect of the invention, there is provided an article comprising the composite of the invention. In some embodiments, the article further comprises an additional agent. In some embodiments, the additional agent is physisorbed to the composite. In some embodiments, the additional agent comprises a volatile (e.g. a volatile organic compound VOC), a liquid, a therapeutically active agent, or any combination thereof. In some embodiments, the additional agent is or comprises a liquid, wherein the liquid is an aqueous liquid (e.g. water or an aqueous solution), an organic solvent, or an organic compound in a liquid state at a temperature between 10 and 50 C.

In some embodiments, the article is selected from a catalyst (e.g. photothermal catalyst), liquid (e.g. water and/or organic solvent) absorbent. In some embodiments, the article if for use in atmospheric water harvesting. In some embodiments, the article is a water sorbent.

### Methods

In another aspect of the invention, there is provided a method of synthesizing the composite of the invention, comprising contacting a plasmonic material with one or more MOF precursor under appropriate conditions, thereby obtaining a mixture; and subjecting the mixture to a light irradiation sufficient for inducing a photothermal activation of the plasmonic material, thereby obtaining the composite. In some embodiments, the plasmonic material is configured to retain its shape and dimensions under conditions of the method of the invention (e.g. light irradiation sufficient for inducing photothermal activation of the plasmonic material). In some embodiments, the plasmonic material comprises plasmonic metal-based material, carbon nanoparticle(s), 1D or 2D material, borophene, boron-nitride nanotube, a boron-based 2D material, titanium dioxide nanoparticle(s), or any combination thereof. Other plasmonic materials are known in the art. In some embodiments, carbon nanoparticle comprises carbon black, carbon nanotube, carbon dot, graphene, graphene oxide, activated charcoal or any combination thereof.

In some embodiments, the plasmonic material is in a form of amorphous metal nanoparticles, as described hereinabove. In some embodiments, the light irradiation is performed using a light source emitting light in a range of the photothermal activation wavelength of the plasmonic material.

In some embodiments, the contacting step is performed in a solvent. In some embodiments, the mixture is a liquid composition comprising a solution of one or more MOF precursors. In some embodiments, the liquid composition comprises the plasmonic material dispersed therewithin. In some embodiments, the liquid composition comprises a w/w ratio between the plasmonic material and the one or more MOF precursor (also referred to as appropriate conditions) between about 1:1000 and about 1:5, between about 1:1000 and about 1:10, between about 1:1000 and about 1:100, including any range between.

In some embodiments, a w/w concentration of the plasmonic material within the liquid composition is between 0.001 and 3%, between 0.001 and 1%, between 0.001 and 0.1%, between 0.01 and 1%, between 0.01 and 3%, between 0.01 and 0.5%, between 0.001 and 0.01%, including any range between.

In some embodiments, a w/w concentration of the MOF precursor (also referred to as appropriate conditions) within the liquid composition is between 0.1 and 30%, between 0.1 and 10%, between 1 and 30%, between 1 and 10%, including any range between.

In some embodiments, the solvent is characterized by a boiling point of at least 90° C., at least 100° C., or between 9° and 200° C., including any range between. In some embodiments, the solubility of the one or more MOF precursors within the solvent is at least 0.1 g/l, at least 1 g/l, at least 5 g/l, at least 10 g/l, at least 50 g/l, at least 100 g/l, including any range between.

In some embodiments, subjecting step comprises irradiating the mixture by light at a wavelength suitable for photothermal activation of the plasmonic material. In some embodiments, irradiation is performed by one or more light source(s), configured to emit light at a suitable wavelength. In some embodiments, the wavelength is in a range between about 200 and 1200 nm, between about 300 and 1000 nm, between about 400 and 900 nm, between about 400 and 1000 nm, between 500 and 900 nm, between 600 and 900 nm, including any range between. In some embodiments, the wavelength is a single wavelength, or a wavelengths range. In some embodiments, the irradiation is performed using a plurality of light sources, wherein each light source has the same or different wavelength or wavelengths range.

In some embodiments, subjecting step comprises irradiating the mixture at a radiation dose sufficient for providing the mixture to a temperature suitable for synthesizing the composite. In some embodiments, the radiation dose is sufficient for providing the mixture (e.g., the liquid composition described hereinabove) to a temperature of at least about 80° C., at least about 90° C., at least about 100° C., at least about 120° C., at least about 150° C., between 8° and 200° C., between 9° and 200° C., between 95 and 150° C., between 9° and 150° C., including any range between. In some embodiments, appropriate conditions further comprise mixing the liquid composition. The inventors observed that during the synthesis of UiO-66, prolonged irradiation of the plasmonic material so that the temperature of the reaction exceeded about 120° C. impaired the structural properties of the resulting composite (e.g. reduced MOF porosity, etc.). A skilled artisan will appreciate that the exact maximum reaction temperature may vary between different MOF species. Furthermore, a skilled artisan will be able to assess the maximum synthesis temperature which doesn't hamper the structural properties of the resulting composite.

In some embodiments, the radiation dose is between 5 and 500 W/ml, between 10 and 100 W/ml, between 20 and 100 W/ml, between 50 and 500 W/ml, between 50 and 100 W/ml, including any range between.

In some embodiments, appropriate conditions comprise irradiation time period of at least one minute (m), at least 0.1 m, at least 3 m, at least 10 m, at least 20 m, at least 30 m, at least 60 m, at least 5 hours, at least 10 hours, between 1 and 60 min, between 1 and 30 min, between 1 and 10 min, including any range between. In some embodiments, the reaction time required for MOF synthesis according to the method of the invention is reduced by at least 1.5 fold, at least 2 fold, at least 3 fold, at least 5 fold, or at least 10 fold, as compared to reaction time using non-photothermal process (e.g. by conventional heating). In some embodiments, the time period is sufficient for synthesizing the composite (e.g. to obtain a substantial conversion of the MOF precursor, and/or embedding the plasmonic material into the composite). Conversion of the MOF precursor and embedding of the plasmonic material can be monitored spectroscopically, such as by recording UV/VIS spectra of the reaction mixture, thereby determining for example the concentration of the plasmonic material in the reaction mixture.

In some embodiments, the method comprises controlling the concentration of the plasmonic material embedded within the composite by modifying the reaction temperature, and/or by modifying the irradiation time. For example, at a short irradiation time required for heating the reaction mixture to a temperature ranging between about 60 and about 80 C, only small fraction of the initial amount of the plasmonic material in the reaction mixture undergoes embedding (i.e. below 20%, or below 10% of the initial amount of the plasmonic material undergoes embedding). Whereas by applying irradiation sufficient for heating the reaction mixture to a temperature above 80 C, such as about 90 C, or about 100 C, almost complete embedding of plasmonic material occurs (e.g. about 90, about 95, or about 99% of the initial amount of the plasmonic material undergoes embedding into the composite).

In some embodiments, the irradiation time is sufficient for inducing incorporation of a predetermined amount of the plasmonic material into the composite. In some embodiments, the predetermined amount comprises at least 30%, at least 50%, at least 60%, at least 80% or between 30 and 99%, between 30 and 80%, between 50 and 99% by weight of the initial amount of the plasmonic material in the mixture. In some embodiments, incorporation is determined by determining the concentration reduction of the plasmonic material (i.e. consumption) relative to the initial concentration in the mixture (before irradiation step). Optionally wherein said consumption is determined by UV/VIS spectroscopy.

In some embodiments, the subjecting step and the contacting step of the method of the invention are performed simultaneously or subsequently. In some embodiments, the step of synthesizing the composite is performed once. In some embodiments, the step of synthesizing the composite is repeated 1, 2, 3, 4, 5, 6, or more times. In some embodiments, the synthesis step disclosed herein (e.g., the method including the contacting and subjecting steps) is performed in one-pot. In some embodiments, the term “one pot” is meant to refer to a synthesis (or to a process) being carried out in a single reaction vessel, typically, but not exclusively, without removing therefrom any intermediate products.

In some embodiments, the method of the invention further comprises isolating the composite from the mixture, to obtain a powderous material. In some embodiments, isolating is performed by filtration, sedimentation, separation, extraction, precipitation, evaporation, etc. In some embodiments, the method further comprises washing the powderous material, and/or drying the powderous material, thereby obtaining a dry composite.

In another aspect of the invention, there is provided a method of synthesizing MOF, comprising contacting a photothermal material with one or more MOF precursor(s) under appropriate conditions, thereby obtaining a mixture; and subjecting the mixture to a light irradiation sufficient for inducing a photothermal activation of the photothermal material, thereby obtaining the MOF. In some embodiments, the “trace amounts” comprise between 0.1 ppm and 50 ppm, or between 0.1 ppm and 25 ppm of the photothermal material, including any range between. The term “trace amounts” may also encompass lower concentrations of the photothermal material, for example a minimum detectable concentration based on the available detection methods. In some embodiments, the photothermal material is plasmonic material. In some embodiments, the appropriate conditions comprise a predefined w/w ratio between one or more MOF precursor(s) and the one or more MOF precursor(s) required for synthesizing the MOF. In some embodiments, the appropriate conditions comprise any of: a solvent, a temperature, specific ambient gas in a closed reactor (such as inert gas, or atmospheric gases), and/or any additional conditions or additives required for synthesizing the MOF.

In some embodiments, the MOF synthesized according to the method of the invention is substantially devoid of the photothermal material comprises a trace amounts of the photothermal material. In some embodiments, the MOF synthesized according to the method of the invention is a substantially pure MOF material, and not a composite. In some embodiments, the w/w content of MOF within the material synthesized according to the method of the invention is between 99 and 100%, between 99.5 and 100%, between 99.9 and 100%, between 99.99 and 100%, including any range between.

In some embodiments, the concentration of the photothermal material within the mixture is sufficient for providing the mixture to a temperature suitable for synthesizing the MOF. In some embodiments, the temperature suitable for synthesizing the MOF is at least about 60° C., at least about 70° C., at least about 80° C., at least about 90° C., including any range between.

In some embodiments, the contacting step is performed in a solvent. In some embodiments, the mixture is a liquid composition comprising a solution of one or more MOF precursors. In some embodiments, the liquid composition comprises the photothermal material dispersed therewithin. In some embodiments, the liquid composition comprises a w/w concentration of the photothermal material of between 5 ppm and 0.1% w/w, between 5 and 500 ppm, between 5 and 100 ppm, between 5 ppm and 0.001% w/w, between 5 ppm and 0.0001% w/w, between 5 ppm and 0. 0.0005% w/w, between 100 ppm and 0.1% w/w, between 10 ppm and 0.01% w/w, between 10 ppm and 0.001% w/w, between 10 ppm and 0.0001% w/w, including any range between.

In some embodiments, the solvent is characterized by a boiling point of at least 60° C., at least 70° C., at least 80° C., at least 90° C., including any range between. In some embodiments, the solubility of the one or more MOF precursors within the solvent is at least 0.1 g/l, at least 1 g/l, at least 5 g/l, at least 10 g/l, at least 50 g/l, at least 100 g/l, including any range between.

In some embodiments, appropriate conditions comprise light irradiation at a radiation dose sufficient for providing the mixture to a temperature suitable for synthesizing the MOF. In some embodiments, the radiation dose is sufficient for providing the mixture (e.g., the liquid composition described hereinabove) to a temperature at least about 50° C., at least about 60° C., at least about 70° C., at least about 80° C., including any range between. In some embodiments, appropriate conditions comprise light irradiation at a radiation dose sufficient for providing the mixture to a temperature ranging between about 50 and about 90° C., between about 50 and about 85° C., between about 55 and about 80° C., between about 55 and about 85° C., between about 60 and about 80° C., including any range between. In some embodiments, irradiation is performed by one or more light source(s), configured to emit light at a suitable wavelength. In some embodiments, the wavelength is in a range between about 200 and 1200 nm, between about 300 and 1000 nm, between about 400 and 900 nm, between about 400 and 1000 nm, between 500 and 900 nm, between 600 and 900 nm, including any range between. In some embodiments, the wavelength is a single wavelength, or a wavelengths range. In some embodiments, the irradiation is performed using a plurality of light sources, wherein each light source has the same or different wavelength or wavelengths range.

In some embodiments, radiation dose is between 5 and 500 W/ml, between 10 and 100 W/ml, between 20 and 100 W/ml, between 50 and 500 W/ml, between 50 and 100 W/ml, including any range between.

In some embodiments, appropriate conditions comprise an irradiation time period of at least one minute (m), at least 0.1 m, at least 3 m, at least 10 m, at least 20 m, at least 30 m, at least 60 m, at least 5 hours, at least 10 hours, including any range between. In some embodiments, appropriate conditions further comprise mixing the liquid composition.

In some embodiments, the subjecting step and the contacting step of the method of the invention are performed simultaneously or subsequently. In some embodiments, the step of synthesizing the composite is performed once. In some embodiments, the step of synthesizing the MOF is repeated 1, 2, 3, 4, 5, 6, or more times. In some embodiments, the synthesis step disclosed herein (e.g., the method including the contacting and subjecting steps) is performed in one-pot.

In some embodiments, the method of the invention further comprises isolating the MOF from the mixture, to obtain a powderous material. In some embodiments, isolating is performed by filtration, sedimentation, separation, extraction, evaporation, precipitation, etc. In some embodiments, the method further comprises washing the powderous material, and/or drying the powderous material, thereby obtaining a dry solid MOF.

In some embodiments, the method of the invention is for catalyzing MOF synthesis via irradiation of the photothermal material. In some embodiments, the photothermal material is utilized in the method of the invention as a catalyst for MOF synthesis.

In some embodiments, the comprises a carbon particle, a plasmonic material, titanium dioxide nanoparticle, or any combination thereof. Other photothermal material are known in the art. In some embodiments, the carbon particle comprises a carbon nanoparticle. In some embodiments, the carbon particle comprises carbon black, graphene, graphene oxide, activated charcoal or any combination thereof.

In some embodiments, plasmonic material comprises a plasmonic metal nanoparticle, borophene, boron-nitride nanotube, a boron-based 2D material, or any combination thereof. In some embodiments, plasmonic metal nanoparticle comprises a noble metal particle. In some embodiments, plasmonic metal nanoparticle comprises gold nanoparticle (gold nano-, and/or micro-flakes; AuNS, AuBPs, etc.), silver nanoparticle, or both. Other plasmonic material are known in the art. In some embodiments, plasmonic material comprises the composite of the invention.

In some embodiments, the method of the invention further comprises isolating the photothermal material form the mixture (e.g. before or after isolating the MOF), thereby obtaining an isolated photothermal material. In some embodiments, the isolated photothermal material is recyclable (i.e. is suitable for use in a subsequent synthesis step of the MOF, as disclosed above). In some embodiments, the photothermal material retain its photothermal properties (i.e. upon irradiation at a suitable wavelength is configured to catalyze MOF synthesis) after 1, 2, 3, 4, 5 or between 2 and 100, between 2 and 10, between 5 and 20, between 5 and 50 reaction cycles, including any range between.

In some embodiments, the amount of the isolated photothermal material is at least 50% or between 50 and 99% by weight, relative to the initial mount of the photothermal material in the mixture. In some embodiments, the photothermal material remains dispersed in the solvent (e.g. supernatant), whereas the composite undergoes precipitation. Accordingly, the photothermal material can be easily isolated from the supernatant by methods known in the art.

To this end the inventors successfully exemplified light induced synthesis of MOFs in the UV/Vis and NIR regions by exploiting the photothermal capabilities of different materials. The generality of the method of the invention was demonstrated by synthesizing four types of MOFs (UiO-66, MIL-88A, HKUST-1 and MOF-5) utilizing different photothermal agents such as carbon black (CB), graphene/graphene oxide, activated charcoal and plasmonic Au nanoparticles, including AuBPs and AuNS with different photothermal activation wavelengths (520 nm, 660 nm and 850 nm).

Remarkably, the inventors discovered that the photothermal synthesis is incredibly rapid when compared with conventional methods thus, improving substantially the efficiency of the reaction. Furthermore, when experimenting with the AuBP induced reaction the inventors found that by controlling reaction temperatures the AuBPs could either be discarded from the final product or kept in the MOF, affording an AuBP embedded MOF (AuBP@UIO-66) that retained its photothermal capabilities. Finally, the plasmonic AuBP@UIO-66 was utilized for ultrafast desorption, MOF activation, and catalysis.

Additional aspect of the invention are disclosed in the Examples section below.

### General:

As used herein the terms “about” or “approximately” refer to ±10%.

The terms “comprises”, “comprising”, “includes”, “including”, “having” and their conjugates mean “including but not limited to”.

The term “consisting of means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

As used herein, the term “treating” includes abrogating, substantially inhibiting, slowing or reversing the progression of a condition, substantially ameliorating clinical or aesthetical symptoms of a condition or substantially preventing the appearance of clinical or aesthetical symptoms of a condition.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments unless the embodiment is inoperative without those elements.

Various embodiments and aspects of the present invention as delineated hereinabove and as claimed in the claims section below find experimental support in the following examples.

### EXAMPLES

Reference is now made to the following examples which, together with the above descriptions, illustrate the invention in a non-limiting fashion.

### Materials

All materials were purchased from Sigma-Aldrich unless noted otherwise. Ultrapure water (type 1, 18.2 MΩ) from Millipore® Direct-Q® 3 with UV was used.

Cetyltrimethylammonium chloride (CTAC) sodium borohydride Reagent Plus 99%, sodium citrate tribasic BioUltra ≥99.5%, gold chloride trihydrate 99.9%, cetyltrimethylammonium bromide (CTAB) ≥99%, ascorbic acid BioXtra ≥99.0%, hydrochloric acid 32%, silver nitrate BioXtra ≥99%, tetraethyl orthosilicate (TEOS) reagent grade 98%, ammonium hydroxide 28% in water 99.9%, N,N-Dimethylformamide (DMF) 99.8% for spectroscopy Acros Organics, Zirconium(IV) chloride (ZrCl₄, ≥99.5%), Terephthalic acid (BDC) 98%, Copper nitrate trihydrate (Cu(NO₃)₂·3H₂O) 99% for analysis ThermoScientific, BTC, Ethanol (EtOH) 99.9% tech Romical, Iron(III) chloride hexahydrate (FeCl₃·6H₂O) ACS reagent 97%, Fumaric acid 99+% Acros Organics, Zinc nitrate hexahydrate (Zn(NO₃)₂·6H₂O) 98% Thermo scientific.

### Methods

Synthesis of AuBPs. Gold bipyramids were synthesized via seed mediated method as reported by (Sinchez-Iglesias, A. et al. High-Yield Seeded Growth of Monodisperse Pentatwinned Gold Nanoparticles through Thermally Induced Seed Twinning. J. Am. Chem. Soc. 139, 107-110 (2017)). 5 ml of HAuCl₄ (10 mM), 1 ml of AgNO₃ (10 mM), and 2 ml of HCl (1 M) were added to a 100 ml solution of CTAB (100 mM) in water. The pre-made seed solution was added right after 0.8 mL of L-ascorbic acid was added with vigorous stirring. Control over AuBP size was achieved by varying the seed solution concentration. The reaction was set at 30° C. for 2 h. Then, the AuBP solution was centrifugate 3 times at 7000×g for 15 min with 1 mM CTAB in water.

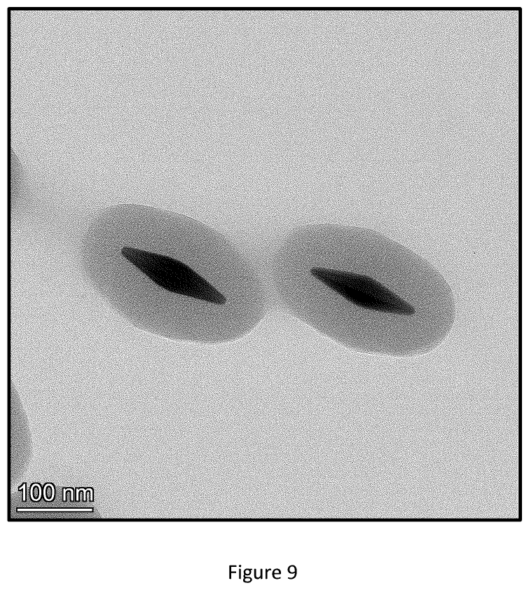

AuBPs Encapsulation. The encapsulation of fresh synthesized AuBPs included two processes. First, the mesoporous silica encapsulation was made by adding 30 μl of 0.1 M NaOH and 10 μl of tetraethyl orthosilicate (TEOS), to a 10 ml solution of 0.3 mM CTAB and 2 OD AuBPs, then, the solution was shaken overnight at 120 rpm and 30° C. After that, the mesoporous encapsulated AuBPs were centrifuge 4 times with ethanol at 7000×g for 10 min. The second processes, Staber encapsulation, was made by adding to a 10 ml solution of 4 OD AuBPs in ethanol 250 μl 28% ammonia in water and 25 μl of 20% TEOS in ethanol were added and the solution was set in a shaker at 120 rpm and 30° C. for 12 to 24 hours. Lastly, the solution was washed 3 times with ethanol and concentrated for use. The structure of AuBPs is presented in FIG. 9.

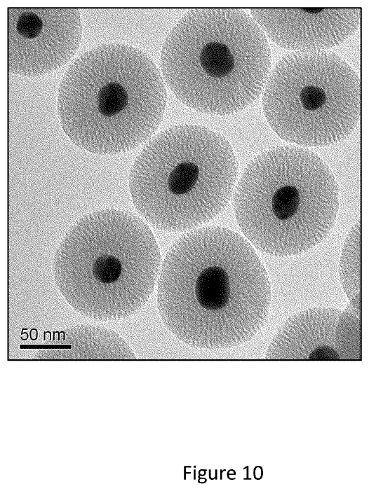

Synthesis of AuNS. Gold nano spheres were synthesized according to method published by Karakocak et al. Hyaluronate coating enhances the delivery and biocompatibility of gold nanoparticles. Carbohydr. Polym. 186, 243-251 (2018). First, 10 mg of HAuCl4 was dissolved in 90 ml of TDW and heated up to 100° C. After boiling, 400 μl of 250 mM sodium citrate solution was added while vigorously stirring the solution. The solution was then aged for 30 minutes until it turned to a red-wine color. After cleaning, the AuNS were encapsulated using the same procedure as the AuBPs. The structure of AuNS is presented in FIG. 10.

### Photothermal MOF Synthesis Procedure

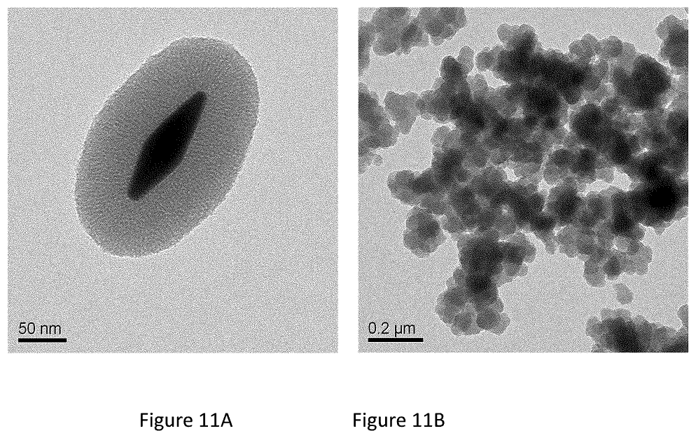

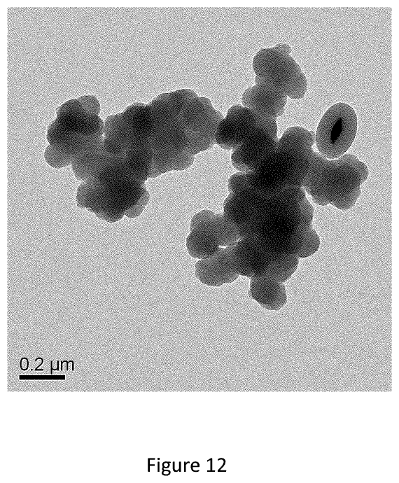

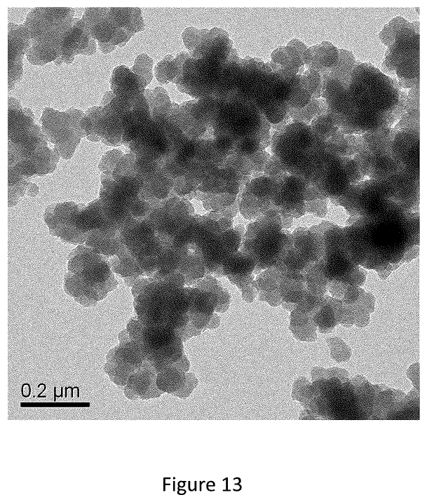

123 mg of ZrCl₄ were measured, then were dissolved in 8.33 ml of DMF and 1.67 ml of concentrated HCl. The solution was sonicated for 5 minutes until the white ZrCl₄ precipitation dissolved, then transferred to heating block for few minutes at 60° C. until the solution got completely clear. 123 mg of terephthalic acid were measured, then were dissolved in 10 ml of DMF. The solution was sonicated for 5 minutes until got clear. Desired volume of AuBPs solution in ethanol was measured into a vial, then the ethanol was evaporated using a rotary evaporator, resulting a dry precipitation of AuBPs on the vial bottom. Equal volumes of the two precursors were transferred into the vial with the dry bipyramids, and then the vial was sonicated for few minutes until the bipyramids got disperse in the solution. The mixture was irradiated with LED (850 nm/660 nm 100 W/8 W) at different duration, resulting a cloudy solution. The solution was centrifuged (3000 g, 5 minutes) and washed three times with DMF and three time with ethanol. The precipitation was dried in vacuum oven at 120° C. for 17 hours, resulting a dried activated UIO-66. Micrographs of UIO-66 are presented in FIGS. 11 and 12.

Photothermal synthesis of UIO-66. AuBP@UiO-66 was synthesized via photothermal reaction based on reported solvothermal synthesis (Katz et. al.). Terephthalic acid (123 mg) was dissolved in 10 ml of DMF. ZrCl₄ (123 mg) was dissolved in 10 ml of HCl:DMF mixture (1:5) and aged in moderate temperatures for 30 minutes to enhance dissolving, the two solution were mixed into a vail and different concentrations of AuBPs were added. During the synthesis, the solution was irradiated by LED (850 nm 100 W). The LED operation and temperature monitoring were controlled by Labview program. Micrographs of AuBP@UiO-66 synthesized at 80° C. are presented in FIG. 12.

Photothermal synthesis of r-MIL-88A. Light induced synthesis of r-MIL-88A was based on a r-MIL-88A solvothermal synthesis reported by (Wang, L. et al. The MIL-88A-Derived Fe 3 O 4-Carbon Hierarchical Nanocomposites for Electrochemical Sensing. Sci. Rep. 5, 1-12 (2015)). 0.4 mmol of FeCl₃—H₂O and 0.4 mmol of fumaric acid were dissolved in 1 ml of ultra-pure water each. Then, the two solutions were mixed and AuBPs were added. The solution was irradiated by 100 W 850 nm LED for 60 minutes at 100° C.

Photothermal synthesis of HKUST-1. Light induced synthesis of HKUST-1 was based on a HKUST-1 microwave assisted synthesis reported by (Seo, Y. K. et al. Microwave synthesis of hybrid inorganic-organic materials including porous Cu3(BTC)2 from Cu(II)-trimesate mixture. Microporous Mesoporous Mater. 119, 331-337 (2009). Chen, B. et al. Synthesis and characterization of the interpenetrated MOF-5. J. Mater. Chem. 20, 3758-3767 (2010)).

0.083 mmol of H₃BTC and 0.152 mmol of Cu(NO₃)₂·3H₂O were dissolved in 1 ml of H₂O:EtOH 1:1 mixture. Then the two solutions were mixed and AuBPs were added. The solution was irradiated by 100 W 850 nm LED for 60 minutes at 120° C.

Photothermal synthesis of MOF-5 Light induced synthesis of MOF-5 was based on a synthesis reported by Chen et al. 0.148 mmol of Zn(NO₃)₂·6H₂O and 0.018 mmol of H₂BDC were dissolved in 1 ml of DMF each. Then the two solutions were mixed, 18 μl of ultra-pure water and AuBPs were added. The solution was irradiated by 100 W 850 nm LED for 120 minutes at 120° C.

Photothermal activation of UIO-66. Dried powder of AuBP@UIO-66 putted into a tube, the tube was sealed and connected to air pump. Then the powder was irradiated by 850 nm 100 W LED and the air pump was turned on simultaneously for 10 minutes.

UiO-66@UiO-66 synthesis process. Dried AuBP@UIO-66 powder was dissolved in UIO-66 precursor solution, the solution was then irradiated by 100 W 850 nm LED for 30 minutes at 100° C. The product was washed, dried, and then dissolved in a new UIO-66 precursor solution, to begin a new cycle as described. This was repeated four times including the initial synthesis.

### Example 1

### Light Induced MOF Synthesis

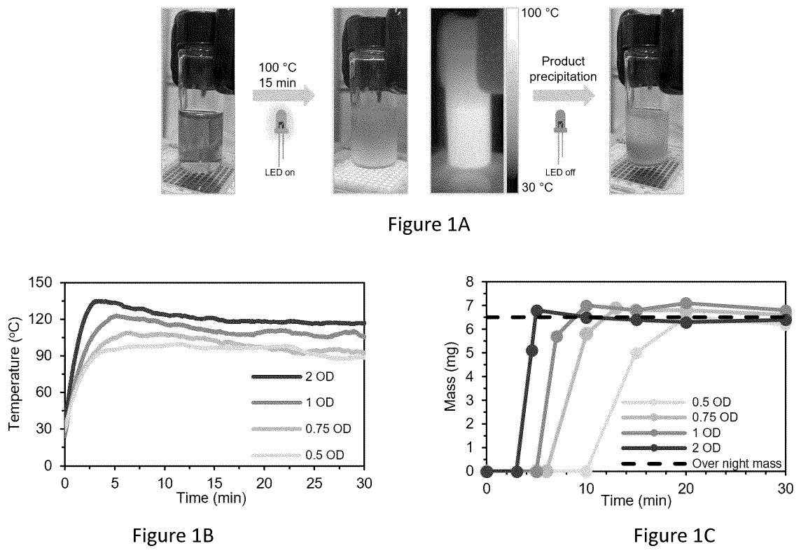

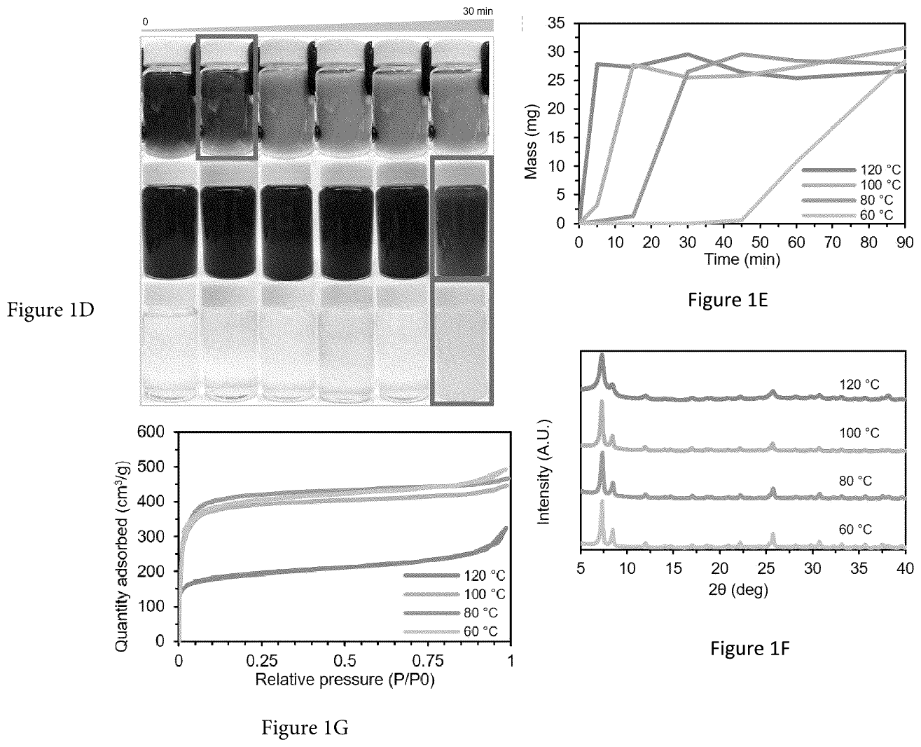

To explore the possibility of developing a light induced MOF synthesis, Inventors modified the conventional solvothermal synthesis of the well-known UIO-6632. This zirconium based MOF has gained vast popularity for its exceptional aqueous, acidic, thermal and mechanical robustness. To begin with a dimethylformamide (DMF) solution of terephthalic acid (BDC), ZrCl4 and HCl was prepared, as suggested by Katz et al. (Katz, M. J. et al. A facile synthesis of UiO-66, UiO-67 and their derivatives. Chem. Commun. 49, 9449-9451 (2013)), to this mixture SiO2 encapsulated AuBPs were added with a photothermal activation wavelength of 850 nm (AuBP850, see Appendix for characterization). AuBPs were encapsulated to avoid deterioration of the bipyramidal structure. Inventors then irradiated the reaction using a simple 8 W, 850 nm LED, and surprisingly Inventors noticed MOF formation within minutes of IR exposure (Appendix). Motivated by the initial result, Inventors prepared a series of solutions with varying AuBP concentrations and irradiated them for 30 minutes (FIGS. 1b and c). The temperature profiles suggest that 0.5 OD of AuBP850 is sufficient to carry the temperature above 90° C. and maintain it throughout the reaction, while increasing the concentration to 2 OD raised the temperature above 120° C. (FIG. 1b). Reaction yield was evaluated and compared to a standard overnight synthesis at 100° C. (FIG. 1c). Remarkably, the results show that all four photothermal reactions achieved the overnight yield within 20 minutes, even at lower temperatures.

To test the newfound rate increase, Inventors scaled-up the reaction mixture (total volume of 20 ml with 5 OD AuBP850) and compared the NIR induced synthesis to reactions carried out in a heating block with and without AuBPs (FIG. 1d). In the photothermal reaction MOF formation could be observed within 10 minutes, whereas in both conventionally heated mixtures MOF formation only began after 30 minutes, indicating that the presence of AuBPs alone does not contribute to the rate increase. Multiple studies on plasmonic photothermal nanoparticles show that the temperature near NP surface is considerably higher than the surrounding ambient temperature. Therefore, inventors hypothesize that the AuBPs act as hotspots where the temperature is greater than that of the solution causing the reaction to accelerate as if it were done in a hotter environment.

Next, inventors studied the plasmonic photothermal reaction (PPR) at different temperatures by regulating IR exposure (see Appendix for temperature regulation method). The results suggest the same trend observed previously where higher temperatures entailed quicker reactions (FIG. 1e). To ensure product quality is not harmed when carrying out PPRs, Inventors analyzed powder X-ray diffractograms (PXRD) and Brunauer-Emmett-Teller (BET) surface areas (SBET) (FIG. 1f, 1g). The PXRD measurements confirm that the resulting MOF is identical to the UIO-66 reported in the literature. SBET results show that MOFs synthesized via PPRs have greater surface areas than conventionally synthesized UIO-66, with the exception of the PPR at 120° C. The increased SBET might be attributed to more defects in the MOF structure 38 resulting from the high temperatures in proximity of the AuBPs. As for the PPR carried out at 120° C., the SBET was substantially decreased indicating that the UIO-66 structure was compromised beyond the point that could be beneficial.

The fact that a decrease in surface area was observed at 120° C., contrary to data in reports utilizing conventional methods strengthens the possibility for elevated local temperatures.

The inventors further conducted a photothermal synthesis of UIO-66 using a non-plasmonic reagent that does not generate hotspots during irradiation. We chose Methylene blue, an organic dye that absorbs light at 660 nm, corresponding to one of our LEDs. Interestingly, the photothermal synthesis of UIO-66 with Methylene blue at 60° C. took 4 hours to complete, which is significantly longer compared to the photothermal synthesis duration at the same temperature using AuBPs. This result supports the suggestion that the high temperatures generated in the close surroundings of the plasmonic particles are crucial for photothermal synthesis.

### Example 2

### Embedding AuBPs in MOF Via Photothermal Synthesis

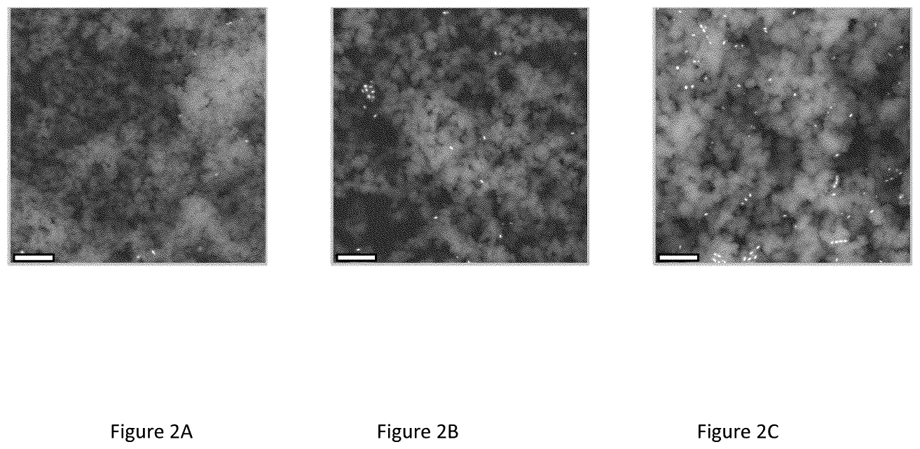

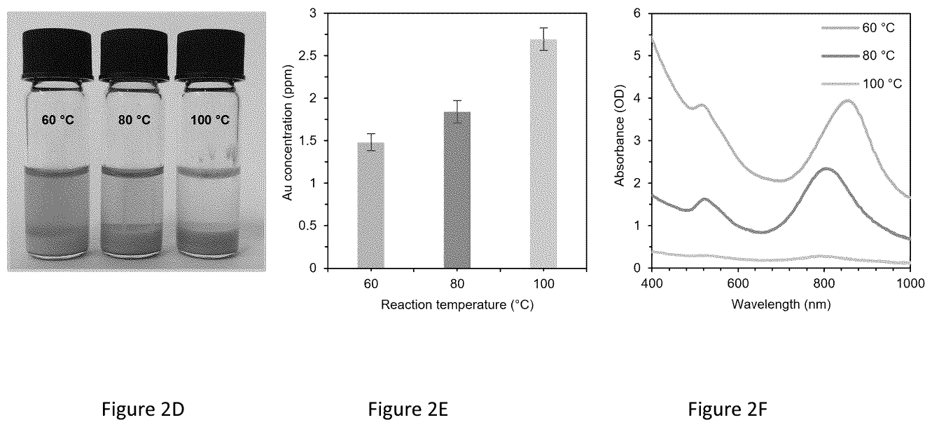

While exploring the photothermal formation of UIO-66 Inventors noticed the reaction temperature had an effect on whether the AuBPs precipitated with the product or remained dispersed in the supernatant. Thus, to gain a better understanding of the observed effect, samples and supernatants produced from different temperature PPRs were analyzed via absorption spectra and SEM images of the UIO-66. The absorption spectra pointed to a clear trend; at lower temperatures more AuBPs are dispersed in the supernatant (FIG. 2e). SEM images showed a complementary trend where more AuBPs were embedded in the MOF at higher temperatures (FIG. 2a-c). Additionally, the SEM images indicate that the MOF particle size grows as the reaction temperature increases.

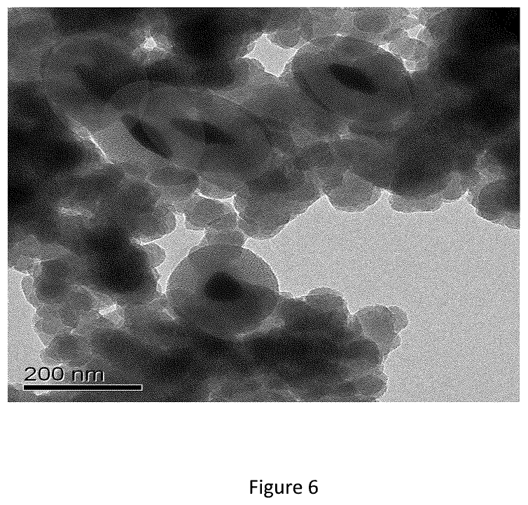

To gain deeper insights and identify the mechanism, we conducted high-resolution TEM imaging of AuBP@UIO-66 samples synthesized at 100° C. Interestingly, the images revealed AuBPs that were partially covered with UIO-66 (FIG. 6), providing evidence in support of the direct attachment mechanism.

To further investigate, we prepared two different solutions, each containing 2 OD of AuBPs and only one of the MOF precursors, under the same conditions used for UIO-66 synthesis. The solutions were divided into three fractions, each heated to different temperatures (60, 80, and 100° C.). While the solution containing only BDC did not show any difference, the solution containing ZrCl₄ heated to 100° C. exhibited a blurry appearance, and at 80° C. showed a slight effect. The 60° C. sample did not display any difference. This led us to suspect that zirconium is attaching to the silica shell at higher temperatures. To confirm this, we performed ICP-OES analysis on the three samples heated with ZrCl₄, and the results confirmed that the sample heated to 100° C. contained a significant amount of zirconium, while the others contained much less.

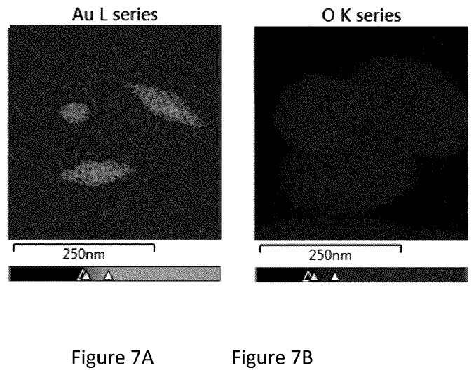

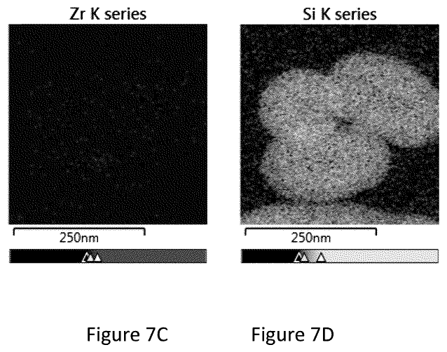

To gain further confirmation, we conducted elemental mapping via EDS analysis under STEM mode on the three samples. The results (FIGS. 7A-E) clearly illustrated the distribution of zirconium on the silica shell, with higher contrast observed around the silica shell as the synthesis temperature increased. This provides strong support for our suggested mechanism, indicating the attachment of zirconium to the silica shell at higher temperatures. Additionally, a control experiment was conducted where AuBPs were conventionally heated in the presence of ZrCl₄. The ICP-OES results showed that approximately 50% less zirconium was attached to the AuBPs compared to those heated up photothermally at all three temperatures. This finding supports our assumption that the localized hotspot generated around the AuBPs plays a significant role in the MOF formation process.

Moreover, the inventors observed that it is possible to control the number of nanoparticles in the final product by setting the reaction temperature accordingly. As the reaction temperature is set by regulating the exposure to NIR, the amount of embedded incorporated AuBPs is tuned by simply controlling LED irradiation. Thus, carrying out a reaction at 60° C. enabled separating the suspended AuBPs from the formed MOF and reusing them for any desired purpose. To demonstrate the efficiency of the recycling process we performed three cycles of UIO-66 photothermal synthesis at 60° C., all yielding similar amounts of product. Recycling the AuBPs considerably decreases the energy cost of synthesizing them, improving on the sustainability of the photothermal method.

### Example 3

### Additional Plasmonic Catalysts

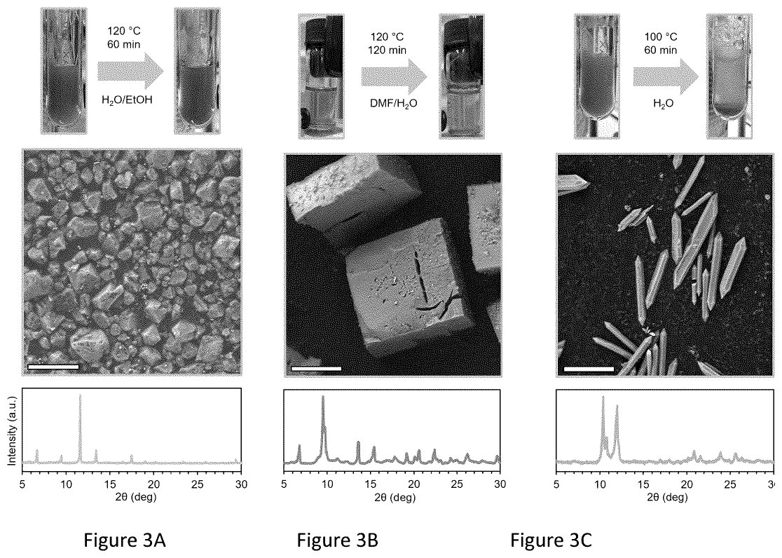

After establishing a light induced synthesis for UIO-66 Inventors sought to test the generality of the photothermal method. Thus, the synthesis of three standard MOFs (r-MIL-88a, HKUST-1 and MOF-5) all having different metal ions (Fe³⁺, Cu²⁺ and Zn²⁺) and involving different reaction conditions (see methods for details) was attempted (FIG. 3a-c). Product characterization via PXRD and SEM validated that all three reactions yielded the anticipated MOF, demonstrating that the photothermal synthesis is not limited to a specific case but can potentially be applied to any MOF. Importantly, the silica layer encapsulating the AuBPs plays a key role in stabilizing the structure and dispersing the nanoparticles, allowing for a robust method.

Furthermore, to test the possibility of alternative light-to-heat converters, Inventors utilized different materials (carbon black, graphene/graphene oxide, activated charcoal AuNS and AuBP₆₆₀,) to generate the necessary heat to synthesize UIO-66. All tested reactions were successful, indicating that any inert photothermal agent that can be stabilized under the reaction conditions could be used to produce MOFs.

Furthermore, the inventors observed incorporation of the photothermal agents (such as carbon black, etc.) into the MOF structure, to obtain exemplary composites of the invention. Of note, the photothermal agents which are not plasmonic metal particles, do not require encapsulation within an inert support matrix disclosed herein.

When experimenting with the different types of photothermal materials Inventors used AuBP₆₆₀, nano gold bipyramids activated with 660 nm light, to explore the possibility of tuning the wavelength needed for MOF synthesis by simply controlling AuBP size. Similarly, Inventors utilized 35 nm encapsulated AuNS with activation wavelength of 520 nm. The successful visible light synthesis showed that the photothermal method is versatile not only when it comes to the desired MOF or identity of the photothermal agent but also in its activation wavelength. Additionally, Inventors also utilized carbon black, a non-plasmonic photothermal material that has a strong absorbance across the visible and NIR range, allowing activation of the photothermal synthesis in several wavelengths without the need to change material.

### Example 4

### AuBP Embedded Plasmonic MOF

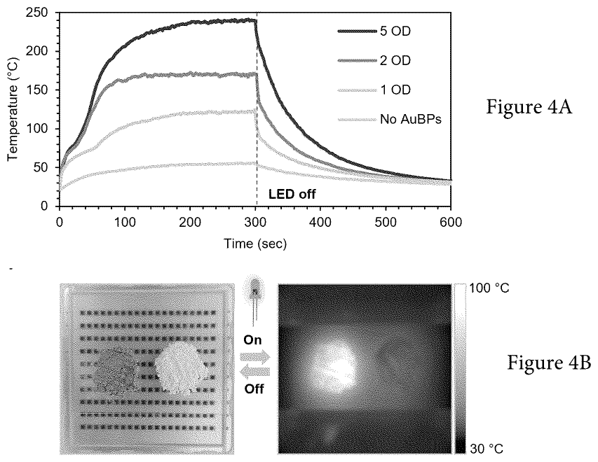

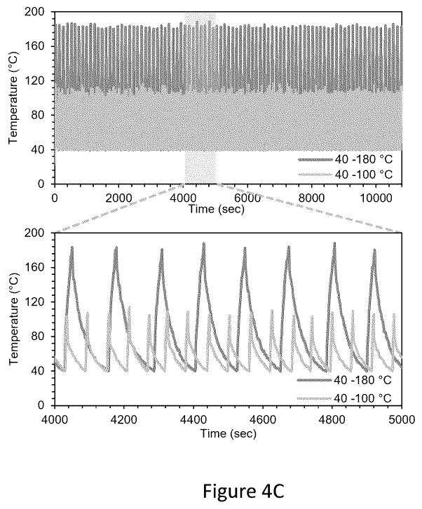

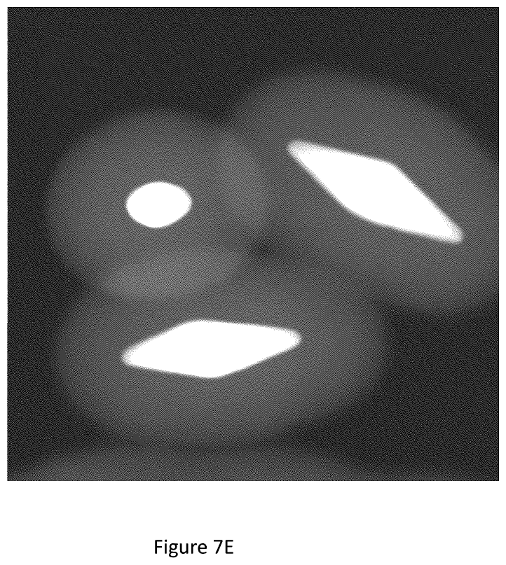

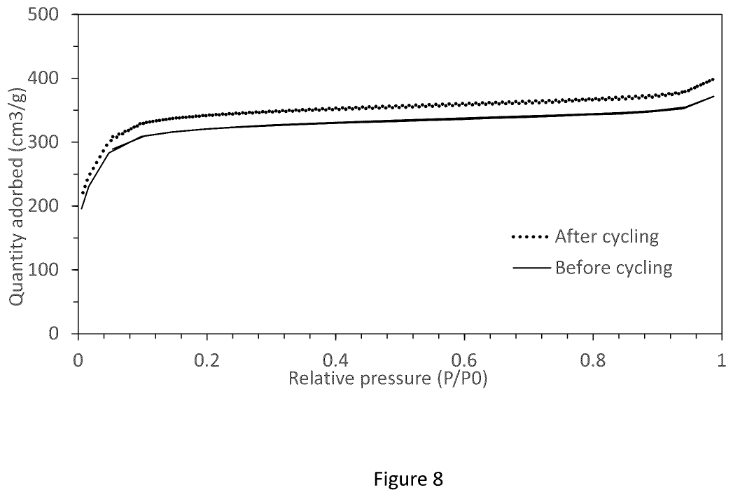

Astonishingly, initial experiments testing the photothermal properties of a washed and dried AuBP₈₅₀@UIO-66, where the composite was irradiated with IR light, produced elevated temperatures surpassing 200° C. (FIG. 4a). Encouraged by the enormous applicative potential of a photo-responsive MOF, Inventors set out to characterize the photothermal abilities of the new material and test it for different applications. To begin with, Inventors prepared three AuBP₈₅₀@UIO-66 samples, as described above, with different concentrations of AuBP₈₅₀ (1, 2 and 5 OD in the initial reaction vial). Subsequently, the samples were washed and dried, and then subjected to irradiation with 850 nm light. The temperature profile during irradiation was recorded and is shown in FIG. 4a. Remarkably, the plasmonic UIO-66 synthesized with a 5 OD concentration of AuBP₈₅₀ reached nearly 250° C. in under 5 minutes of exposure. The AuBP₈₅₀@UIO-66 prepared with lower concentrations of nanoparticles also responded to the IR light reaching well over 100° C. To evaluate the stability of the photothermal feature over time Inventors cycled the temperature of a 20 OD-AuBP₈₅₀@UIO-66 between 40-180° C. and 40-100° C. for 3 hours, by turning on and off the NIR LED (FIG. 4b). The results show incredible stability throughout both cycling experiments completing the first and last cycles in approximately the same times. PXRD and BET analyses of the AuBP₈₅₀@UIO-66 after the cycling experiments were performed to ensure the crystalline MOF structure remained intact (FIG. 8). Furthermore, very steep heating ramps of 40 to 180° C. in an average of 22 seconds are achieved hinting at the immense applicative potential of the plasmonic photothermal MOF.

Careful inspection of the thermal profiles presented in FIG. 4a revealed an inflection point at around 80° C. recurring in all three curves during the heating process. Inventors suspected this might be due to the evaporation of leftover solvents trapped in the MOF matrix. Thus, Inventors postulate that a photothermal MOF could be highly useful in the photoactivated release of solvents or target molecules adsorbed by the MOF. The Inventors envisioned utilizing AuBP₈₅₀@UIO-66 as a photothermal catalyst to induce any chemical reaction or a chemical process requiring heating.

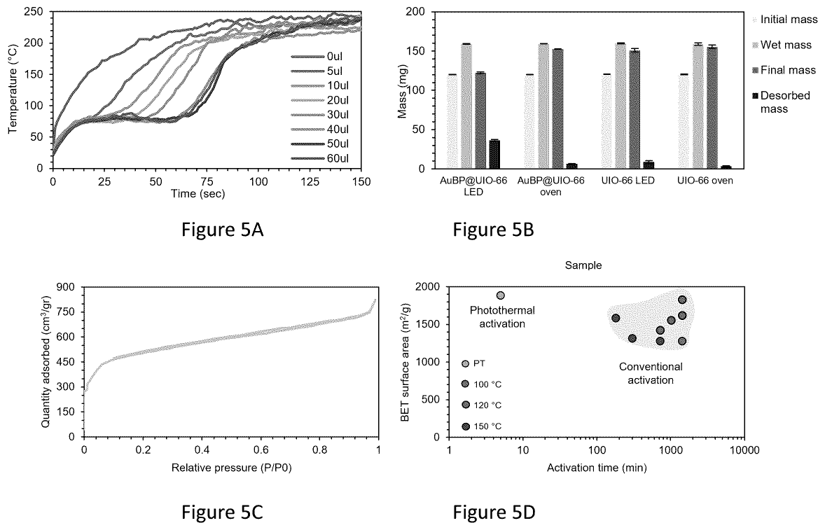

Utilizing MOFs to produce potable water in arid environments by adsorbing water from the air is a promising idea that has shown great applicative potential. Consequently, light induced desorption capabilities of the PMOF were tested by adding increasing amounts of water to a AuBP₈₅₀@UIO-66, irradiating the PMOF with an 850 nm LED, and analyzing the temperature profiles. The inflection point spotted in aforementioned experiments reemerged at roughly the same temperature for all samples, with the exception of a PMOF that was kept dry. Furthermore, increasing the initial volume of water adsorbed by the MOF extended the plateau caused by the evaporation of the adsorbate up to a saturation point where the amount of water the MOF could hold was exceeded (FIG. 5a).

To compare the photothermal desorption mechanism with conventional heating desorption, AuBP₈₅₀@UIO-66 and UIO-66 samples were loaded with identical amounts of water and subjected to both heating methods. For photothermal release the samples were irradiated for one minute to 85° C. (slightly higher than the inflection point observed earlier) with an 850 nm LED, and for conventional heating the samples were kept in an oven set to 95° C. for the same duration. Remarkably, the AuBP₈₅₀@UIO-66 exposed to NIR released the entire amount of water within a minute, whereas the control samples failed to release even a quarter of the adsorbed water, showcasing the impressive photothermal activity of the plasmonic MOF. To understand the extent of the differences between release techniques a UIO-66 sample was left in the oven until completely dry, ultimately taking 45 minutes to fully desorb the water.

The impressive results obtained for the light induced desorption led us to look for additional ways to exploit the photothermal feature of the new composite. Thus, Inventors decided to try “activating” the MOF via the photothermal response. The porous structure of the MOF can adsorb solvents, moisture and other molecules during synthesis, therefore it is crucial to “activate” the MOF, meaning expelling the adsorbate, before using it. The standard procedure for MOF activation comprises exchanging solvents via repeated centrifugation to a more volatile option and simply placing the MOF in a vacuum oven for prolonged periods of time. To check if the proposed method can efficiently expel the solvent, two identical samples of AuBP₈₅₀@UIO-66 (5 OD) were activated with different methods. A conventionally activated sample was put under vacuum at 120° C. for 17 hours, while the photothermal activation was carried out by exposing the MOF to NIR under vacuum. To ensure the activation of both samples was complete, S_{BET} was examined (FIG. 5). Surprisingly, the photoactivation of the AuBP₈₅₀@UIO-66 was complete after only 5 minutes, an enormous improvement on current conventional procedures.

Finally, the photothermal AuBP₈₅₀@UIO-66 was utilized as a heat source to initiate UIO-66 formation. The plasmonic MOF was added to a UIO-66 precursor solution and the solution was irradiated with NIR light, heating the reaction resulting in UIO-66 synthesis. The product could not be separated from the initial AuBP₈₅₀@UIO-66, essentially affording a photothermal MOF with less AuBPs. This process could be repeated at least 4 times, greatly increasing the amount of MOF that can be synthesized from a given amount of AuBPs. Coupling the MOFs excellent catalytic properties with the ability to create intense heat at its surface can potentially enable very efficient procedures to be carried out by the presented methodology.

Current invention provides the development of a new light induced MOF synthesis utilizing photothermal materials. The novel procedure was found to be robust, versatile, and very rapid, making it an ideal alternative to the conventional time and energy consuming solvothermal syntheses. AuBPs used to generate the heat necessary for UIO-66 formation could be introduced into the MOF in-situ, affording AuBP₈₅₀@UIO-66, demonstrating a new concept for the incorporation of well-defined nanoparticles to MOF matrices. Perhaps the most exciting feature of the MOF-NP composite is the retention of the AuBP's photothermal capabilities, yielding a photoresponsive MOF. Importantly, repeated activation of the photothermal response for up to 3 hours did not affect the efficiency of heat generation or MOF structure, namely S_{BET} and PXRD results remained unaltered. The combination of outstanding light-to-heat conversion with the unique properties of MOFs may serve as a cornerstone for a wide range of potential applications. To highlight the vast impact of what is possible, photothermal desorption, MOF activation and catalysis were performed, affording exciting results. Possibly the most impressive is the completion of MOF activation within a few minutes, while standard procedures can take up to 24 hours. Naturally, Inventors expect to continue investigating the photothermal MOF, testing new opportunities for applications and expanding the insight into the interactions between PNPs and MOFs.

Although the invention has been described in conjunction with specific embodiments thereof, it is evident that many alternatives, modifications, and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A composite comprising a metal-organic framework (MOF) and a photothermal material, wherein:
said composite is a crystalline solid;
said photothermal material is a plasmonic material in a form of a plurality of nanoparticles chemisorbed to the MOF;
said photothermal material is characterized by a photothermal activation wavelength in a range between 200 and 1200 nm;
wherein a w/w concentration of the plasmonic material within said composite is at least 0.05%.

2. The composite of claim 1, wherein said crystalline solid is characterized by an average particle size between 10 nm and 500 μm, and wherein a w/w concentration of the plasmonic material within said composite is between 0.05 and 20%; and wherein the plurality of nanoparticles are enclosed within the MOF.

3. The composite of claim 1, wherein said photothermal material comprises a carbon particle, a plasmonic metal-based material, magnetic nanoparticles, borophene, boron-nitride nanotube, a boron-based 2D material, or any combination thereof.

4. The composite of claim 3, wherein said plasmonic metal-based material comprises plasmonic metal nanoparticles, wherein each of the plasmonic metal nanoparticles is encapsulated by an oxide shell.

5. The composite of claim 4, wherein said crystalline solid is doped with the plasmonic metal nanoparticles; optionally wherein the plasmonic metal nanoparticles comprise an elemental state metal selected from Ag, Au, Fe, Cu, Pd, Ni, Pt, including any combination and any alloy thereof; and wherein said oxide shell comprises a metalloid oxide, a metal oxide, or both.

6. The composite of claim 4, wherein said plasmonic metal nanoparticles are characterized by an average particle size between 5 and 500 nm; optionally wherein the plasmonic metal nanoparticles are plasmonic Au nanoparticles characterized by a photothermal activation wavelength between about 500 and about 1000 nm; wherein said Au nanoparticles are selected from nanospheres (AuNS), nanorods (AuNR), Au cubes, Au stars, and bipyramids (AuBP), or a combination thereof.

7. (canceled)

8. (canceled)

9. (canceled)

10. The composite of claim 5, wherein said plasmonic material is embedded within a matrix of said MOF; wherein said metalloid oxide is silica; wherein said MOF is a porous MOF characterized by a BET surface area between 700 and 3000 m2/z.

11. (canceled)

12. The composite of claim 1, wherein said composite is configured to emit thermal radiation upon light irradiation at the photothermal activation wavelength; wherein said thermal radiation comprises a temperature increase of said composite by at least 50° C. wherein said increase is measured relative to a temperature of said composite before irradiation.

13. (canceled)

14. A dispersion comprising the composite of claim 1 dispersed in a solvent.

15. The dispersion of claim 14, wherein said composite is configured to emit thermal radiation sufficient for increasing a temperature of said solvent; wherein said increasing from about 40 at about 180° C. after 22 seconds irradiation time; and wherein a concentration of the composite within the solvent corresponds to 240 ppm of the plasmonic material.

16. (canceled)

17. A method of synthesizing the composite of claim 1, comprising contacting a photothermal material with one or more MOF precursor, thereby obtaining a mixture; and irradiating said mixture by light sufficient for inducing a photothermal activation of said photothermal material, thereby obtaining said composite.

18. The method of claim 17, wherein a w/w ratio between said plasmonic material and said one or more MOF precursor within said mixture is between about 0.1:100 and about 1:1; and wherein a concentration of said photothermal material within said mixture is between 0.001 and 3% w/w.

19. The method of claim 17, wherein said irradiating is performed for a time period sufficient for consumption of at least 80% of said photothermal material present in said mixture, optionally wherein said consumption is determined by UV/VIS spectroscopy.

20. The method of claim 17, wherein said photothermal activation is sufficient for heating said mixture to a temperature of at least about 90° C., or between about 100 and 200° C.

21. The method of claim 17, wherein said irradiating and said contacting are performed simultaneously or subsequently and wherein said irradiating and said contacting further comprise mixing.

22. The method of claim 17, wherein said contacting is performed in a solvent characterized by a boiling point of at least about 90° C., and capable of at least partially dissolving said one or more MOF precursor.

23. The method of claim 17, wherein said one or more MOF precursor are characterized by a solubility within said solvent of at least 0.1 g/L.

24. The method of claim 17, wherein the method further comprises isolating said photothermal material from said mixture.

25.-36. (canceled)
